(19) United States
(12) Patent Application Publication
(10) Pub. No.: US 2010/0023967 A1
(43) Pub. Date: Jan. 28, 2010

(54) ADVERTISEMENT BROADCASTING SYSTEM WITH LOCATION-IDENTIFYING ABILITY

(76) Inventors: Fa-Yu Wang, Taichung City (TW); Yen-Ming Chu, Taichung City (TW)

Correspondence Address: NIKOLAI & MERSEREAU, P.A., 900 SECOND AVENUE SOUTH, SUITE 820, MINNEAPOLIS, MN, 55402, US

(21) Appl. No.: 12/178,041

(22) Filed: Jul. 23, 2008

(51) Int. Cl. H04N 7/025

(52) U.S. Cl. 725/35

(57) ABSTRACT

An advertisement broadcasting system with location-identifying ability includes a central processing unit coupled with a GPS positioning module, a storage unit, and a broadcasting unit. The GPS positioning module receives a positioning signal transmitted from a satellite. According to the received positioning signal, the central processing unit identifies the current position of the advertisement broadcasting system and reads the storage unit to retrieve advertisement information corresponding to that location. The central processing unit then transmits the retrieved advertisement information to the broadcasting unit for broadcasting.

### FIELD OF THE INVENTION

The present invention relates to an advertisement broadcasting system with location-identifying ability; and more particularly to an advertisement broadcasting system that has a GPS positioning module for receiving a positioning signal transmitted from a satellite, and a central processing unit for identifying a current position of the advertisement broadcasting system according to the received positioning signal and retrieving corresponding advertisement information from a storage unit for broadcasting.

### BACKGROUND OF THE INVENTION

In the digital era, various digital electronic products have been developed and widely applied in different fields, particularly in signboards for advertising and marketing purpose. For example, traditional posters and signboards showing only images have been gradually replaced by electronic signboards that not only show visual effect, but also sound effect to attract more consumers' attention and thus achieve much better advertising effect than ever before. In addition, the subjects presented by the electronic signboards are readily replaceable. Therefore, the electronic signboards are environmentally friendly and more practical in used compared to the traditional posters or signboards.

A conventional electronic signboard is composed of a display and a player. After a compact disc containing advertisement information is inserted into the player, the advertisement information on the compact disc is shown to consumers via the display. Such an electronic signboard is frequently mounted at a public place, such as a department store, a hospital, an elevator, a mass transportation means, etc. In general, the advertisement information stored in the compact disc is repeatedly displayed for a long time until the compact disc is manually replaced. When this type of conventional electronic signboard is mounted in a department store and the advertisement information thereof is not updated in real time, consumers just could not be informed of the newest information about the bargains or the new collections of the season. Moreover, when the conventional electronic signboard is mounted in a mass transportation means, the repeatedly displayed advertisement information does not vary with different locations arrived by the mass transportation means. Under such circumstances, when the mass transportation means has moved from a place to another place, the electronic signboard on the mass transportation means might still display advertisement information that is completely not relevant to that place. Therefore, the passengers are not informed of the local marketing information via the signboard. Compared to the traditional posters and signboards, the current electronic signboards are not improved in terms of the ability of updating the advertisement information in real time.

In conclusion, the currently available electronic signboards have the following disadvantages:
1. The advertised contents must be periodically updated manually.
2. The advertised contents could not be timely updated with local advertisement information.

### SUMMARY OF THE INVENTION

A primary object of the present invention is to provide an advertisement broadcasting system with location-identifying ability. According to a satellite positioning signal, the advertisement broadcasting system is able to identify its current location to broadcast corresponding advertisement in real time.

Another object of the present invention is to provide an advertisement broadcasting system that is able to update the advertisement information thereof in real time.

To achieve the above and other objects, the advertisement broadcasting system with location-identifying ability according to the present invention includes a GPS positioning module, a storage unit, a central processing unit, and a broadcasting unit. The central processing unit is coupled with the GPS positioning module, the storage unit, and the broadcasting unit. The GPS positioning module receives a positioning signal transmitted from a satellite. According to the received positioning signal, the central processing unit identifies a current position of the advertisement broadcasting system and reads the storage unit to retrieve corresponding advertisement information. The central processing unit then transmits the corresponding advertisement information to the broadcasting unit for broadcasting.

The advertisement broadcasting system may further include a communication unit linked with a plurality of servers via a wireless network, so that the advertisement information stored in the storage unit may be updated with the information at the servers in real time.

In brief, the present invention provides the following advantages:
1. The advertisement broadcasting system is able to identify its current position and to timely broadcast advertisement information corresponding to that position.
2. The advertisement information stored on the storage unit of the system may be updated in real time.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1 is a block diagram of an advertisement broadcasting system according to a first embodiment of the present invention;

FIG. 2 is a more detailed block diagram of the advertisement broadcasting system of FIG. 1;

FIG. 3 is a schematic diagram showing the use of the advertisement broadcasting system of the present invention; and

FIG. 4 is a block diagram of an advertisement broadcasting system according to a second embodiment of the present invention.

### DETAILED DESCRIPTION OF THE PREFERRED EMBODIMENTS

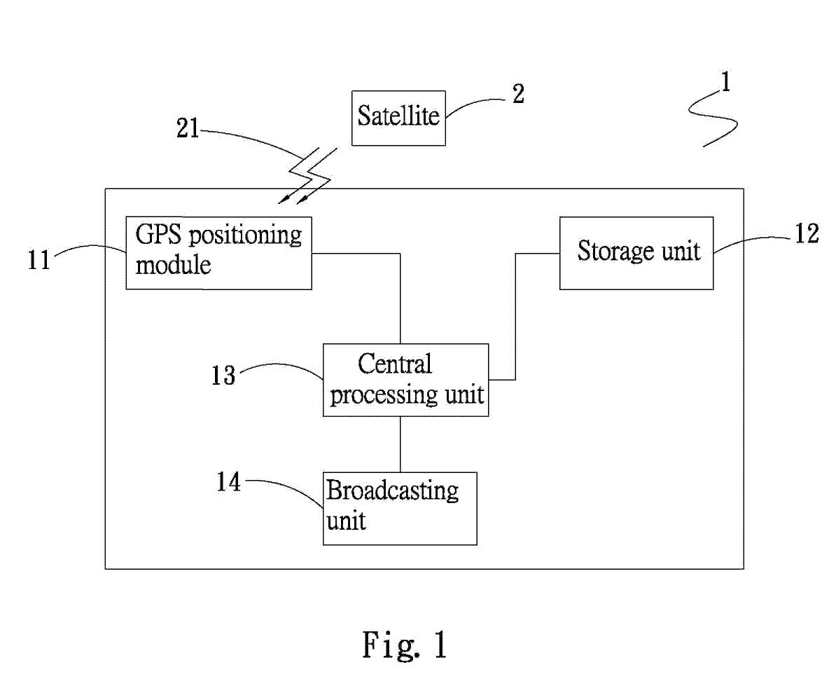

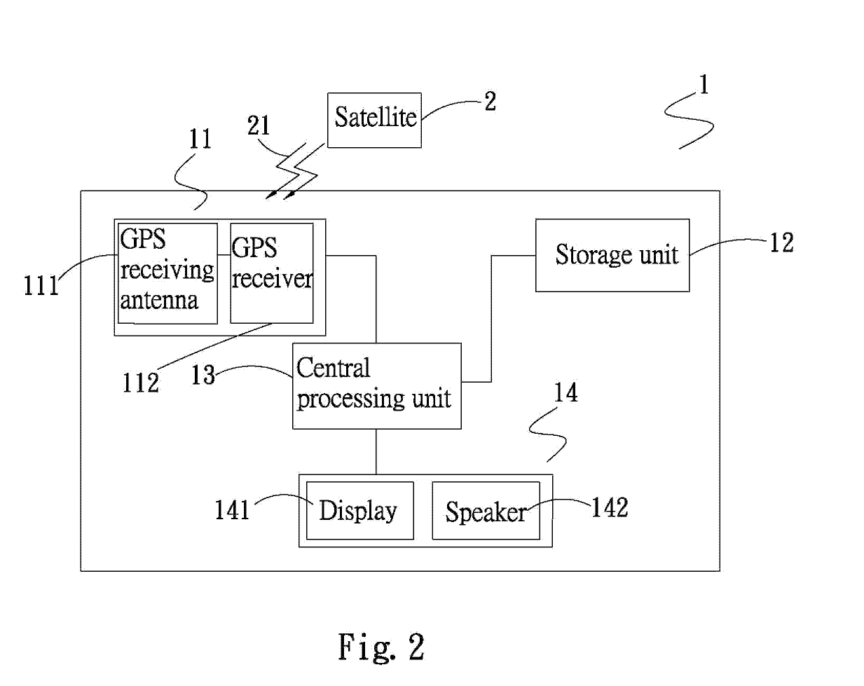

Please refer to FIGS. 1 and 2 that are system block diagrams of an advertisement broadcasting system with location-identifying ability 1 according to a first preferred embodiment of the present invention. The advertisement broadcasting system 1 is mounted on at least one mobile end, which may be any movable carrier, such as a vehicle, or a person. The advertisement broadcasting system 1 is capable of identifying the location of the mobile end and broadcasting advertisements corresponding to that location.

The advertisement broadcasting system 1 includes a GPS (global positioning system) positioning module 11, a storage unit 12, a central processing unit 13, and a broadcasting unit 14. The GPS positioning module 11 receives a positioning signal 21 transmitted from a satellite 2 to locate a current position of the mobile end. According to the positioning signal 21 received by the GPS positioning module 11, the central processing unit 13 identifies the position of the mobile end, and reads the storage unit 12 to retrieve advertisement information corresponding to the current location of the mobile end. The central processing unit 13 then transmits the retrieved advertisement information to the broadcasting unit 14 for broadcasting.

The GPS positioning module 11 includes a GPS receiving antenna 111 and a GPS receiver 112 coupled with the GPS receiving antenna 111. The GPS receiving antenna 111 receives the positioning signal 21 transmitted from the satellite 2 and transmits the received positioning signal 21 to the GPS receiver 112. The GPS receiver 112 then transmits the positioning signal 21 to the central processing unit 13, which computes the positioning signal 21 so as to identify the current location of the mobile end. The storage unit 12 may be a hard disc or a memory card (not shown) for storing advertisement information.

The broadcasting unit 14 includes a display 141 and a speaker 142. The display 141 is used to show video signals output from the central processing unit 13, while the speaker 142 is used to play audio signals output from the central processing unit 13. Therefore, the broadcasting unit 14 is able to broadcast the advertisement information in video mode and audio mode simultaneously. With the aid of images and sounds, the broadcasted advertisement information may provide an even better advertising effect.

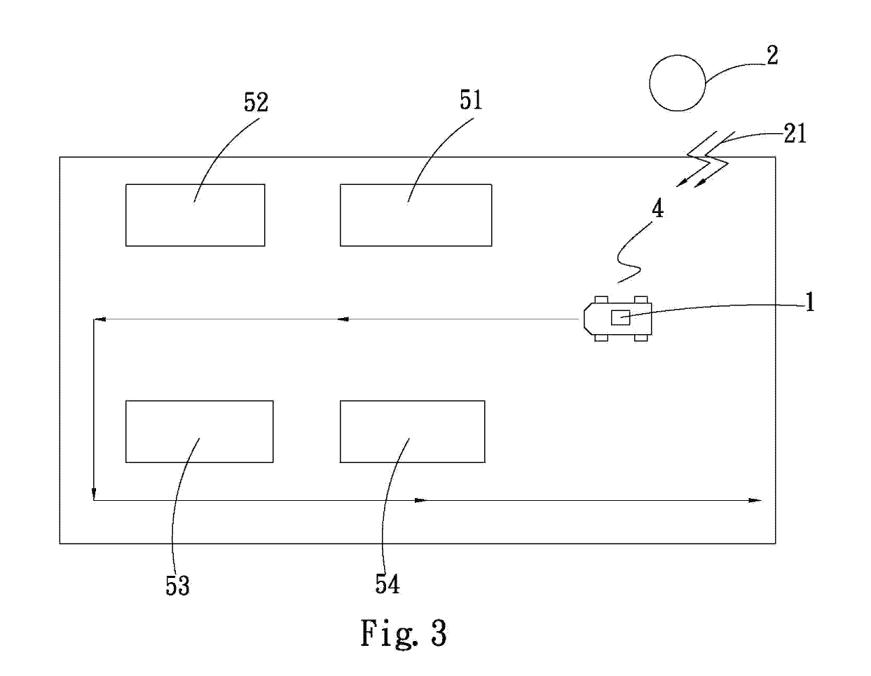

Please refer to FIGS. 1 and 3 at the same time. The advertisement broadcasting system 1 of the present invention may be mounted on different mobile carriers 4, such as taxicabs, demonstration cars, mass transportation facilities, etc. Of course, the advertisement broadcasting system 1 may also be manually carried around (not shown). As illustrated in FIG. 3, the mobile carrier 4 is scheduled to pass a first building 51, a second building 52, a third building 53, and a fourth building 54. When the mobile carrier 4 approaches the first building 51, the GPS positioning module 11 receives a positioning signal 21 transmitted from the satellite 2 to locate the current position of the mobile carrier 4. According to the positioning signal, 21 received by the GPS positioning module 11, the central processing unit 13 identifies the current location of the mobile carrier 4, and reads the storage unit 12 to retrieve advertisement information in connection with internal or surrounding conditions of the first building 51. The central processing unit 13 then transmits the retrieved advertisement information to the broadcasting unit 14 for broadcasting. Similarly, when the mobile carrier 4 sequentially approaches the second building 52, the third building 53, and the fourth building 54, the GPS positioning module 11 of the advertisement broadcasting system 1 receives the positioning signals transmitted from the satellite 2 to locate current positions of the mobile carrier 4. Thereafter, via the broadcasting unit 14, advertisement information in connection with each of the second, the third, and the fourth buildings 52, 53, 54 as well as the surroundings thereof are sequentially displayed and broadcasted.

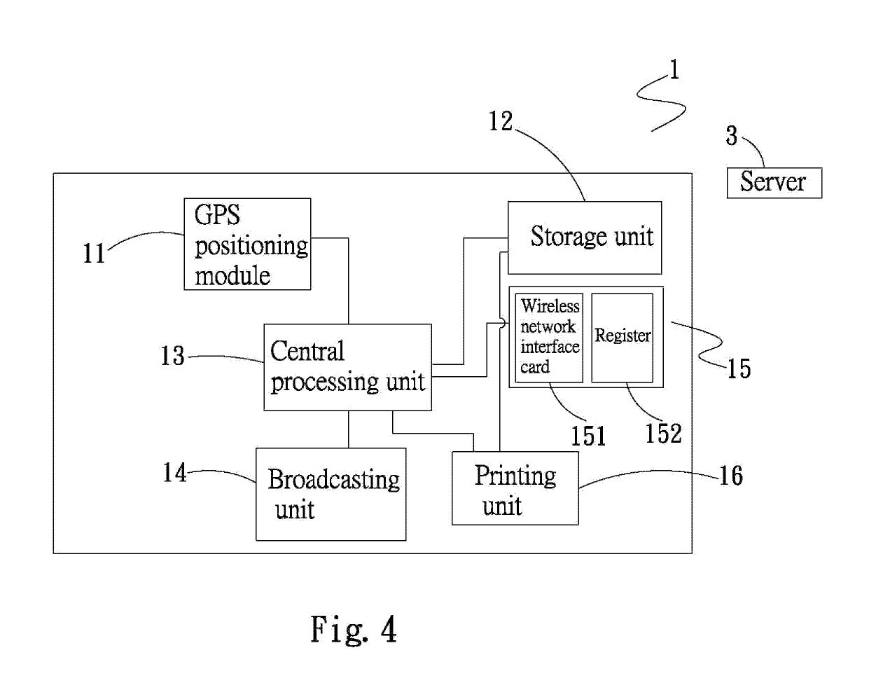

FIG. 4 shows an advertisement broadcasting system 1 according to a second embodiment of the present invention, which is generally structurally similar to the first embodiment but further includes a communication unit 15. The communication unit 15 includes a wireless network interface card 151 and a register 152. The communication unit 15 is coupled with the central processing unit 13 and the storage unit 12. The wireless network interface card 151 is linked with a plurality of servers 3 via a wireless network. Information at the servers 3 can be transmitted to the wireless network interface card 151 via the wireless network and stored in the storage unit 12, so that the advertisement information stored in the storage unit 12 may be updated in real time. The servers 3 may be separately mounted at different fixed locations, such as the above-mentioned first, second, third, and fourth buildings 51, 52, 53, 54. Alternatively, the servers 3 may be mounted in various big-scale shopping areas, freeway service areas, etc. (not shown), such that when the mobile carrier 4 passes the shopping areas, freeway service areas, etc., the advertisement information stored in the storage unit 12 can be updated in real time. Accordingly, the problem of manually updating the advertisement information as in the conventional technologies is overcome.

In addition, the advertisement broadcasting system 1 in the second embodiment may further includes a printing unit 16, which may be a printer coupled with the central processing unit 13 and the storage unit 12 to enable real-time printing of related advertisement information, such as discount coupons, DM showing the bargains of the season.

The present invention has been described with some preferred embodiments thereof and it is understood that many changes and modifications in the described embodiments can be carried out without departing from the scope and the spirit of the invention that is intended to be limited only by the appended claims.

What is claimed is:

1. An advertisement broadcasting system with location-identifying ability, comprising:
a GPS positioning module for receiving a positioning signal transmitted from a satellite to locate a current position of the advertisement broadcasting system;
a storage unit for storing advertisement information thereon;
a central processing unit coupled with the GPS positioning module and the storage unit for identifying the current position of the advertisement broadcasting system according to the positioning signal received by the GPS positioning module, and reading the storage unit to retrieve and output advertisement information corresponding to the current position of the advertisement broadcasting system; and
a broadcasting unit coupled with the central processing unit for receiving and broadcasting the advertisement information output from the central processing unit.

2. The advertisement broadcasting system with location-identifying ability as claimed in claim 1, wherein the storage unit is selected from the group consisting of a hard disc and a memory card.

3. The advertisement broadcasting system with location-identifying ability as claimed in claim 1, wherein the GPS positioning module includes a GPS receiving antenna and a GPS receiver coupled with the GPS receiving antenna; the GPS receiving antenna receiving the positioning signal transmitted from the satellite and transmitting the received positioning signal to the GPS receiver; and then, the GPS receiver transmitting the positioning signal to the central processing unit.

4. The advertisement broadcasting system with location-identifying ability as claimed in claim 1, further comprising a printing unit coupled with the central processing unit and the storage unit for printing related advertisement information.

5. The advertisement broadcasting system with location-identifying ability as claimed in claim 4, wherein the printing unit is a printer.

6. The advertisement broadcasting system with location-identifying ability as claimed in claim 1, wherein the broadcasting unit includes a display for showing video signals output from the central processing unit and a speaker for playing audio signals output from the central processing unit.

7. The advertisement broadcasting system with location-identifying ability as claimed in claim 1, wherein the broadcasting unit broadcasts the advertisement information in video mode and audio mode simultaneously.

8. The advertisement broadcasting system with location-identifying ability as claimed in claim 6, wherein the broadcasting unit broadcasts the advertisement information in video mode and audio mode simultaneously.

9. The advertisement broadcasting system with location-identifying ability as claimed in claim 1, further comprising a communication unit coupled with the central processing unit and the storage unit, and the advertisement information stored on the storage unit maybe updated through linking with a wireless network signal via the communication unit.

10. The advertisement broadcasting system with location-identifying ability as claimed in claim 9, wherein the communication unit includes a wireless network interface card and a register; and the wireless network interface card being linked with a plurality of servers via a wireless network, so that information at the servers may be stored on the storage unit.
